(19) United States
(12) Patent Application Publication
(10) Pub. No.: US 2024/0230327 A1
(43) Pub. Date: Jul. 11, 2024

(54) NON-CONTACT PROBE

(71) Applicant: MITUTOYO CORPORATION, Kanagawa (JP)

(72) Inventors: Toshihisa TAKAI, Tokyo (JP); Kentaro TAMURA, Tokyo (JP); Yasushi UESHIMA, Ibaraki (JP)

(73) Assignee: MITUTOYO CORPORATION, Kanagawa (JP)

(21) Appl. No.: 18/403,224

(22) Filed: Jan. 3, 2024

(30) Foreign Application Priority Data
Jan. 5, 2023 (JP) 2023-000435

(51) Int. Cl. G01C 3/02; G01C 25/00

(52) U.S. Cl. CPC G01C 3/02; G01C 25/00

(57) ABSTRACT

A non-contact probe includes: a light irradiating section that scans a measurement target object with spot-like laser beam; an image-capturing section that captures an image of the laser beam reflected by the measurement target object by using a plurality of pixel columns selected from a light-reception surface including a plurality of pixel columns, and generates a captured image; a position sensing section that senses an image-formation position of the laser beam on the captured image; and a pixel column changing section that selects a different plurality of pixel columns such that the image-formation position is included in the selected plurality of pixel columns.

### CROSS-REFERENCE TO RELATED APPLICATIONS

The present application claims priority to Japanese Patent Applications number 2023-000435, filed on Jan. 5, 2023 contents of which are incorporated herein by reference in their entirety.

### BACKGROUND OF THE INVENTION

The present disclosure relates to a non-contact probe that determines the distance to a measurement target object. Japanese Patent Application Publication No. 2021-189143 discloses a coordinate measuring machine having a non-contact probe that scans a measurement portion of a work with spot-like laser beam (beam spot), and measures the distance to the measurement portion. The non-contact probe has a light-reception surface (specifically, a line sensor) that receives the laser beam, and, when the distance is to be determined in accordance with the principle of triangulation, the distance to the measurement portion is determined from an image-formation position of the laser beam reflected by the measurement portion, on a pixel column (one pixel column) of a light-reception surface.

Meanwhile, if a frame or the like that fixes a lens, a mirror or a lens of a light-receiving optical system expands or contracts due to the occurrence of a temperature change during measurement, an image-formation position on a light-reception surface is shifted in some cases. For example, there is a fear that if a shift amount of the image-formation position in an orthogonal direction orthogonal to a direction in which pixel columns are arrayed on the light-reception surface becomes greater than the pixel size of the pixel columns undesirably, it becomes not possible to sense the image-formation position undesirably. Note that although one may also consider preventing the occurrence of the malfunction described above by increasing the pixel size of the pixel columns, the resolution deteriorates in this case. In addition, since shift amounts of the image-formation position that can be coped with are limited to those not exceeding the pixel size, it is not possible to cope with very large shift amounts.

### SUMMARY OF THE INVENTION

Therefore, the present disclosure has been made in view of these matters, and an object thereof is to appropriately sense an image-formation position even if a temperature change occurs.

One aspect of the present disclosure provides a non-contact probe including: a light irradiating section that scans a measurement target object with spot-like laser beam; an image-capturing section that captures an image of the laser beam reflected by the measurement target object by using a plurality of pixel columns selected from a light-reception surface including a plurality of pixel columns, and generates a captured image: a position sensing section that senses an image-formation position of the laser beam on the captured image: and a pixel column changing section that selects a different plurality of pixel columns such that the image-formation position is included in the selected plurality of pixel columns.

### BRIEF DESCRIPTION OF THE DRAWINGS

FIG. 1 is a block diagram for explaining the configuration of a non-contact probe 10 according to one embodiment.

FIG. 2 is a simplified schematic diagram depicting optical elements included in the non-contact probe 10.

FIG. 3 is a schematic diagram for explaining effective pixel columns on which signal processing is implemented in an area sensor 32.

FIG. 4 is a schematic diagram for explaining a line sensor 130 according to a first comparative example.

FIG. 5 is a schematic diagram for explaining a line sensor 230 according to a second comparative example.

FIG. 6 is a schematic diagram for explaining a change of the effective pixel columns in the present embodiment.

FIG. 7 is a schematic diagram for explaining the relationship between temperature changes and movement amounts of an image-formation position.

FIGS. 8A and 8B are each a schematic diagram for explaining a method of identifying a temperature increase or a temperature decrease on the basis of a moving direction of the image-formation position.

### DESCRIPTION OF THE PREFFERED EMBODIMENTS

Hereinafter, the present disclosure will be described through exemplary embodiments, but the following exemplary embodiments do not limit the invention according to the claims, and not all of the combinations of features described in the exemplary embodiments are necessarily essential to the solution means of the invention.

### Configuration of Non-Contact Probe

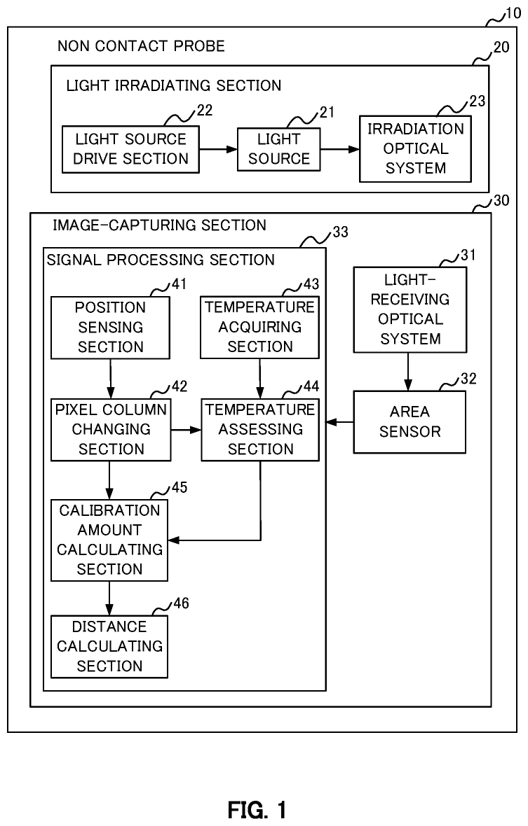

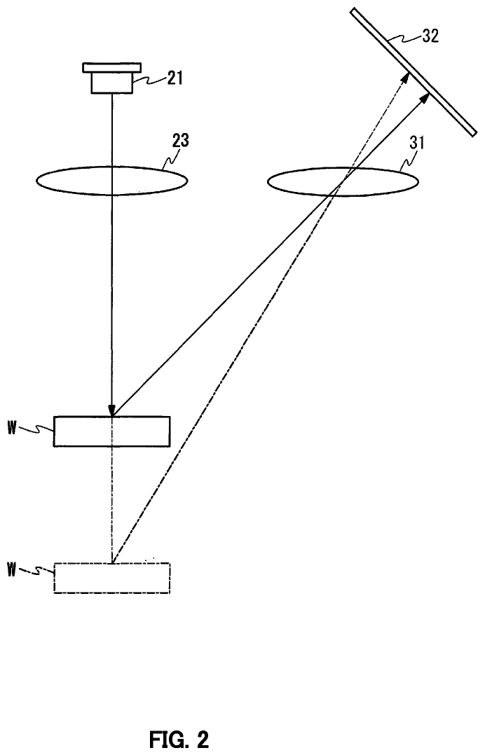

The configuration of a non-contact probe 10 according to one embodiment is explained with reference to FIG. 1 and FIG. 2.

FIG. 1 is a block diagram for explaining the configuration of the non-contact probe 10 according to the one embodiment. FIG. 2 is a simplified schematic diagram depicting optical elements included in the non-contact probe 10.

For example, the non-contact probe 10 is attached to a coordinate measuring device that measures the coordinates of a work which is a measurement target object. The non-contact probe 10 is supported by a moving mechanism that can move on the coordinate measuring device relative to the work. The non-contact probe 10 measures the distance to the measurement target object by irradiating the measurement target object with laser beam, and capturing an image of the laser beam reflected by the measurement target object.

As depicted in FIG. 1, the non-contact probe 10 has a light irradiating section 20 and an image-capturing section 30. The light irradiating section 20 scans a measurement target object W with spot-like laser beam. The light irradiating section 20 has a light source 21 that emits the laser beam, a light source drive section 22 that drives the light source 21, and an irradiation optical system 23.

For example, the light source 21 is a laser diode, and emits the laser beam with a light amount according to a drive voltage applied from the light source drive section 22.

The irradiation optical system 23 is an optical system that irradiates the measurement target object W with the laser beam emitted from the light source 21. The irradiation optical system 23 includes a collimator lens that collimates the laser beam emitted from the light source 21, and an irradiation-side scanning mirror (e.g. a galvanometer mirror, etc.) that changes the irradiation direction of the laser beam.

The image-capturing section 30 captures an image of a beam spot which is the laser beam reflected by the measurement target object W by using a plurality of pixel columns selected from a light-reception surface including a plurality of pixel columns, and generates a captured image. The image-capturing section 30 has a light-receiving optical system 31, an area sensor 32 that receives the laser beam via the light-receiving optical system 31, and a signal processing section 33.

The light-receiving optical system 31 is an optical system that guides the laser beam reflected by the measurement target object W to the area sensor 32. The light-receiving optical system 31 includes a light-reception-side scanning mirror (e.g. a galvanometer mirror, etc.) that reflects the laser beam reflected by the measurement target object W, and a focusing lens that focuses the laser beam reflected by the light-reception-side scanning mirror.

The area sensor 32 has a plurality of pixels arranged over a predetermined region, and the plurality of pixels form the light-reception surface of the area sensor 32. Each pixel is provided with a light receiving element that can receive the beam spot. Because of this, charge according to a light-reception amount is accumulated in each element of the area sensor 32.

The signal processing section 33 generates a captured image by reading out the charge accumulated in the light receiving element of each pixel of the area sensor 32 sequentially, and implementing signal processing. The signal processing section 33 reads out the charge accumulated in the light receiving elements of some pixel columns (effective pixel columns) of all the pixels in the area sensor 32, and implements the signal processing. By limiting the effective pixel columns on which the signal processing is implemented in this manner, it is possible to prevent processing time of the signal processing section 33 from becoming longer undesirably.

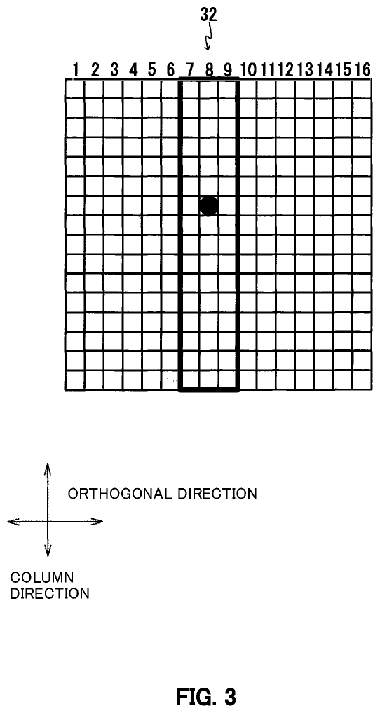

FIG. 3 is a schematic diagram for explaining the effective pixel columns on which the signal processing is implemented in the area sensor 32. A column direction depicted in FIG. 3 means the pixel array direction of the pixel columns, and an orthogonal direction depicted in FIG. 3 means a direction orthogonal to the column direction. Whereas the area sensor 32 includes sixteen pixel columns in FIG. 3, this is not the sole example, and the area sensor 32 may include more than sixteen pixel columns. The signal processing section 33 sets some pixel columns of the sixteen pixel columns of the area sensor 32 as the effective pixel columns, reads out the charge accumulated in each light receiving element of the effective pixel columns, and implements the signal processing. Specifically, the signal processing section 33 sets three pixel columns (the seventh, eighth and ninth pixel columns in FIG. 3) as the effective pixel columns, and implements the signal processing.

Meanwhile, if a frame or the like that fixes a lens, a mirror or a lens of the light-receiving optical system 31 expands or contracts due to the occurrence of a temperature change during measurement, an image-formation position on the light-reception surface of the image-capturing section 30 moves in some cases. For example, there is a fear that if a movement amount of the image-formation position in the orthogonal direction orthogonal to the direction in which the pixel columns are arrayed on the light-reception surface becomes greater than the pixel size of the effective pixel columns undesirably, it becomes not possible to sense the image-formation position undesirably.

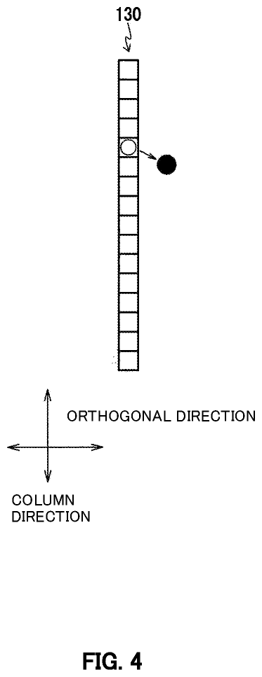

FIG. 4 is a schematic diagram for explaining a line sensor 130 according to a first comparative example. In FIG. 4, an image-formation position before movement is represented by a white circle (∘), and the image-formation position after the movement is represented by a black circle (●). Unlike the present embodiment, the line sensor 130 of one column receives a beam spot in the first comparative example. Because of this, as depicted in FIG. 4, if a movement amount of the image-formation position in the orthogonal direction orthogonal to the column direction becomes greater than the pixel size of the pixel column undesirably, the image-formation position cannot be sensed.

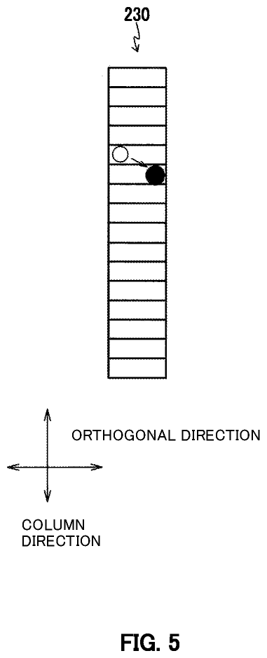

FIG. 5 is a schematic diagram for explaining a line sensor 230 according to a second comparative example. In FIG. 5 also, an image-formation position before movement is represented by a white circle, and the image-formation position after the movement is represented by a black circle. In the second comparative example, the pixel size in the horizontal direction is greater than in the first comparative example. Although the image-formation position after the movement can be sensed in the second comparative example, the pixel resolution deteriorates due to the large pixel size undesirably, and a movement amount of the image-formation position cannot be determined precisely. In addition, in the second comparative example also, since movement amounts of the image-formation position that can be coped with are limited to those not exceeding the pixel size, it is not possible to cope with very large movement amounts.

In comparison to the first comparative example and the second comparative example mentioned above, the non-contact probe 10 of the present embodiment senses the image-formation position of the beam spot on the captured image, and selects different effective pixel columns such that the image-formation position is included in the selected plurality of pixel columns (i.e. effective pixel columns).

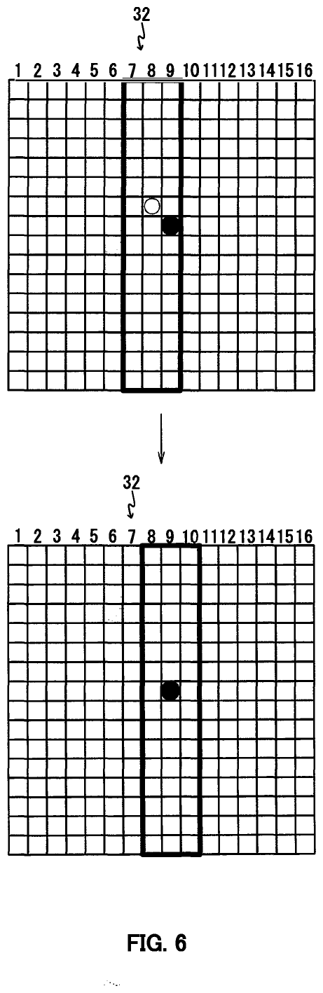

FIG. 6 is a schematic diagram for explaining a change of the effective pixel columns in the present embodiment. In FIG. 6 also, the image-formation position before movement is represented by a white circle, and the image-formation position after the movement is represented by a black circle. It is assumed here that the effective pixel columns before the change are the seventh, eighth and ninth pixel columns that are continuous in the orthogonal direction. Since the image-formation position has moved from the eighth pixel column to the ninth pixel column, the signal processing section 33 changes the effective pixel columns to the eighth, ninth and tenth pixel columns to follow the movement of the image-formation position. In this manner, the signal processing section 33 changes the effective pixel columns to follow movement of the image-formation position due to a temperature change in real time. This results in the image-formation position being positioned at the center of the effective pixel columns, the image-formation position becomes unlikely to move out of the effective pixel columns even if the image-formation position moves thereafter, and the image-formation position can be sensed appropriately. Note that whereas it is assumed in the description above that the effective pixel columns are three pixel columns that are continuous in the orthogonal direction, this is not the sole example, and, for example, it may be assumed that the effective pixel columns are five pixel columns that are continuous in the orthogonal direction.

Hereinbelow, the detailed configuration of the signal processing section 33 that changes the effective pixel columns along with movement of the image-formation position is explained.

### Detailed Configuration of Signal Processing Section

As depicted in FIG. 1, the signal processing section 33 has a position sensing section 41, a pixel column changing section 42, a temperature acquiring section 43, a temperature assessing section 44, a calibration amount calculating section 45 and a distance calculating section 46.

The position sensing section 41 senses the image-formation position of the laser beam in a captured image. For example, the position sensing section 41 senses the image-formation position of the beam spot in a captured image that was generated immediately before. The position sensing section 41 senses the image-formation position by identifying a pixel having received the beam spot in the effective pixel columns. Note that, in a case where the beam spot was received by and spreads across a plurality of pixels, the position sensing section 41 identifies the plurality of pixels that received the beam spot.

The pixel column changing section 42 selects a different plurality of pixel columns such that the image-formation position is included in the selected plurality of pixel columns. That is, in a case where the image-formation position moved, the pixel column changing section 42 shifts the effective pixel columns such that the image-formation position is included in the effective pixel columns. By changing the effective pixel columns in real time such that the effective pixel columns follow the image-formation position in accordance with movement of the image-formation position in this manner, it is possible to suppress movement of the image-formation position out of the effective pixel columns thereafter.

The pixel column changing section 42 selects a different plurality of pixel columns such that the image-formation position is positioned at the center of the selected plurality of pixel columns in the orthogonal direction orthogonal to the pixel column direction. For example, if the image-formation position shifts from the eighth pixel column to the ninth pixel column in a case where the effective pixel columns are the seventh to ninth pixel columns as depicted in FIG. 6, the pixel column changing section 42 changes the effective pixel columns to the eighth to tenth pixel columns. This results in the moved image-formation position being positioned at the center (a pixel in the ninth pixel column) of the effective pixel columns after the change, and the possibility of the image-formation position moving out of the effective pixel columns lowers even if the image-formation position moves thereafter again.

The temperature acquiring section 43 acquires an external temperature sensed by a temperature sensor. The external temperature is a temperature around the non-contact probe 10, and influences a lens or a mirror of the non-contact probe 10. For example, the temperature sensor is provided to the non-contact probe 10. The temperature acquiring section 43 outputs the acquired external temperature to the temperature assessing section 44. Note that the temperature acquiring section 43 does not store the acquired external temperature on a storage section, but sequentially outputs the latest external temperature to the temperature assessing section 44.

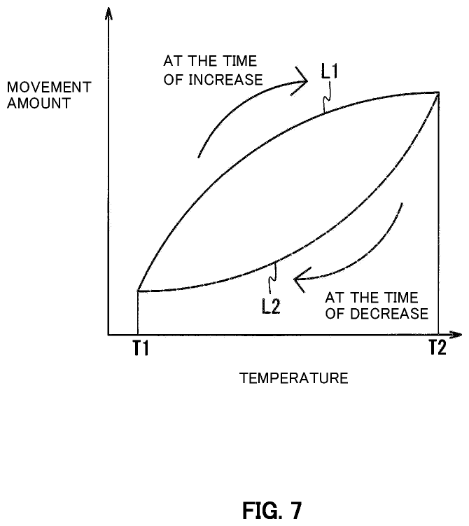

Meanwhile, it is known that movement (shifting) of the image-formation position is caused by temperature changes, and movement amounts of the image-formation position differ depending on whether there is a temperature increase or a temperature decrease. Specifically, even if a temperature change amount at the time of a temperature increase, and a temperature change amount at the time of a temperature decrease are the same, movement characteristics of the image-formation position differ as depicted in FIG. 7.

FIG. 7 is a schematic diagram for explaining the relationship between temperature changes and movement amounts of the image-formation position. FIG. 7 depicts a graph representing the relationship between temperature changes and movement amounts of the image-formation position as determined from experiments. In a case where the external temperature increases from a temperature T1 to a temperature T2, a movement amount of the image-formation position that accompanies the temperature increase exhibits characteristics represented by a solid line L1. On the other hand, in a case where the external temperature decreases from the temperature T2 to the temperature T1, a movement amount of the image-formation position that accompanies the temperature decrease exhibits characteristics represented by a broken line L2. As can be known from FIG. 7, the solid line L1 and the broken line L2 do not match.

In the present embodiment, in order to identify a movement amount of the image-formation position caused by a temperature change more precisely, the non-contact probe 10 assesses whether the image-formation position is moving at the time of a temperature increase or the image-formation position is moving at the time of a temperature decrease. In order to make such an assessment, the temperature assessing section 44 depicted in FIG. 1 is provided.

The temperature assessing section 44 assesses whether there is a temperature increase or a temperature decrease of the external temperature on the basis of the moving direction of movement of the image-formation position at the time when the pixel column changing section 42 changed the effective pixel columns, from the image-formation position sensed last time by the position sensing section 41. Specifically, the temperature assessing section 44 assesses whether there is a temperature increase or a temperature decrease of the external temperature in accordance with toward which the image-formation position moves in the orthogonal direction.

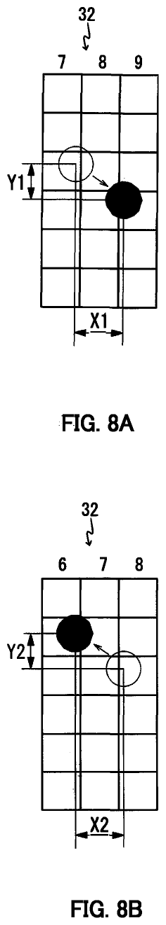

FIGS. 8A and 8B are each a schematic diagram for explaining a method of identifying a temperature increase or a temperature decrease on the basis of a moving direction of the image-formation position. For convenience of explanation, only a part of the effective pixel columns is depicted in FIGS. 8A and 8B. In addition, in FIGS. 8A and 8B also, the image-formation position sensed last time is represented by a white circle, and the image-formation position sensed currently is represented by a black circle. Since the image-formation position has moved to the lower right in FIG. 8A, the temperature assessing section 44 determines that there is a temperature increase. On the other hand, since the image-formation position has moved to the upper left in FIG. 8B, the temperature assessing section 44 determines that there is a temperature decrease.

As described above, in a case where a moving direction of the image-formation position is a first direction (specifically, the right direction) in the orthogonal direction, the temperature assessing section 44 assesses that the external temperature acquired by the temperature acquiring section 43 is increasing. On the other hand, in a case where a moving direction of the image-formation position is a second direction (specifically, the left direction) opposite to the first direction, the temperature assessing section 44 assesses that the external temperature acquired by the temperature acquiring section 43 is decreasing. Thereby, even without storing changes of the external temperature, the temperature assessing section 44 can assess whether the external temperature is increasing or decreasing in real time when the image-formation position moved. Note that the first direction and the second direction are preset in accordance with characteristics or the like of the non-contact probe 10.

When the image-formation position moved, the calibration amount calculating section 45 calculates a calibration amount for calculating the distance to the measurement target object on the basis of the image-formation position. For example, in a case where the pixel column changing section 42 changed the effective pixel columns as depicted in FIG. 6, the calibration amount calculating section 45 calculates a calibration amount according to the change of the effective pixel columns.

The calibration amount calculating section 45 calculates a calibration amount for calibrating the distance to the measurement target object W from movement amounts of movement of the image-formation position in the column direction and the orthogonal direction at the time when the pixel column changing section 42 changed the pixel columns, from the image-formation position sensed last time by the position sensing section 41. For example, when the image-formation position moves as depicted in FIG. 8A due to a temperature change, the calibration amount calculating section 45 calculates a calibration amount from a movement amount X1 in the orthogonal direction and a movement amount Y1 in the column direction. Similarly, when the image-formation position moves as depicted in FIG. 8B, the calibration amount calculating section 45 calculates a calibration amount from a movement amount X2 in the orthogonal direction and a movement amount Y2 in the column direction.

In addition, the calibration amount calculating section 45 may calculate a temperature calibration amount for calibrating the distance to the measurement target object W on the basis of a result of assessment by the temperature assessing section 44. The calibration amount calculating section 45 makes different a temperature calibration amount corresponding to the temperature of the image-formation position in a case where the temperature assessing section 44 assesses that there is a temperature increase, and a temperature calibration amount corresponding to the temperature of the image-formation position in a case where the temperature assessing section 44 assesses that there is a temperature decrease. For example, the calibration amount calculating section 45 makes the temperature calibration amount in a case where it is assessed that there is a temperature increase greater than the temperature calibration amount in a case where it is assessed that there is a temperature decrease. Thereby, a temperature calibration amount corresponding to a temperature change and a change of the movement amount depicted in FIG. 7 can be determined. Note that the values of temperature calibration amounts are pre-calibrated.

The distance calculating section 46 calculates the distance to the measurement target object W on the basis of the image-formation position sensed by the position sensing section 41 on a captured image. Note that the distance to the measurement target object W calculated by the distance calculating section 46 decreases as the image-formation position gets closer to the top side in the column direction depicted in FIG. 3, and increases as the image-formation position gets closer to the bottom side in the column direction depicted in FIG. 3.

The distance calculating section 46 calculates the distance to the measurement target object W by adding a calibration amount calculated by the calibration amount calculating section 45 to the image-formation position sensed by the position sensing section 41. For example, the distance calculating section 46 calculates the distance to the measurement target object W by adding a calibration amount corresponding to movement amounts of the image-formation position in the column direction and the orthogonal direction at the time when the pixel column changing section 42 changed the effective pixel columns.

In addition, the distance calculating section 46 calculates the distance to the measurement target object W by adding a temperature calibration amount determined by the calibration amount calculating section 45 to the image-formation position sensed by the position sensing section 41. For example, in a case where the temperature assessing section 44 determines that there is a temperature increase, the distance calculating section 46 calculates the distance to the measurement target object W on the basis of a temperature calibration amount corresponding to a temperature increase, and in a case where the temperature assessing section 44 determines that there is a temperature decrease, the distance calculating section 46 calculates the distance to the measurement target object W on the basis of a temperature calibration amount corresponding to a temperature decrease. By calculating the distance to the measurement target object W as described above, the distance to the measurement target object W can be calculated precisely even if a temperature change occurs.

### Effects of Present Embodiment

The non-contact probe 10 of the embodiment mentioned above senses the image-formation position of the laser beam (beam spot) on a captured image, and selects different effective pixel columns such that the image-formation position is included in the selected plurality of pixel columns (i.e. effective pixel columns). This results in the image-formation position being positioned at the center of the effective pixel columns since the effective pixel columns are changed such the effective pixel columns follow movement of the image-formation position in real time even if the image-formation position moved due to a temperature change, and the possibility of the image-formation position moving out of the effective pixel columns lowers even if the image-formation position moves thereafter again. As a result, the image-formation position can be kept being sensed appropriately even if temperature changes occur.

Although the present disclosure has been explained thus far by using an embodiment, the technical scope of the present disclosure is not limited by the scope of the description of the embodiment described above, but can be modified and changed variously within the scope of the gist. For example, all or some of devices can be configured in a functionally or physically distributed/integrated manner in any units. In addition, embodiments of the present disclosure include also new embodiments that are generated by combining any ones of a plurality of embodiments. Effects of the new embodiments generated by the combination combine effects of the original embodiments.

What is claimed is:

1. A non-contact probe comprising:
a light irradiating section that scans a measurement target object with spot-like laser beam;
an image-capturing section that captures an image of the laser beam reflected by the measurement target object by using a plurality of pixel columns selected from a light-reception surface including a plurality of pixel columns, and generates a captured image;
a position sensing section that senses an image-formation position of the laser beam on the captured image; and
a pixel column changing section that selects a different plurality of pixel columns such that the image-formation position is included in the selected plurality of pixel columns.

2. The non-contact probe according to claim 1, wherein the pixel column changing section selects a different plurality of pixel columns such that the image-formation position is positioned at a center of the selected plurality of pixel columns in an orthogonal direction orthogonal to a pixel column direction.

3. The non-contact probe according to claim 1, further comprising a calibration amount calculating section that calculates a calibration amount for calibrating a distance to the measurement target object on a basis of movement amounts of movement of an image-formation position in the column direction and the orthogonal direction at a time when the pixel column changing section has changed the pixel columns, from an image-formation position sensed last time by the position sensing section.

4. The non-contact probe according to claim 3, further comprising a distance calculating section that calculates the distance to the measurement target object by adding the calibration amount calculated by the calibration amount calculating section to the image-formation position sensed by the position sensing section.

5. The non-contact probe according to claim 1, further comprising a temperature assessing section that assesses whether there is a temperature increase or a temperature decrease of an external temperature on a basis of a moving direction of movement of an image-formation position at a time when the pixel column changing section has changed the pixel columns, from an image-formation position sensed last time by the position sensing section.

6. The non-contact probe according to claim 5, further comprising a temperature acquiring section that acquires the external temperature sensed by a temperature sensor, wherein
the temperature assessing section
assesses that the external temperature acquired by the temperature acquiring section is increasing in a case where the moving direction is a first direction in an orthogonal direction orthogonal to a pixel column direction, and
assesses that the external temperature acquired by the temperature acquiring section is decreasing in a case where the moving direction is a second direction opposite to the first direction.

7. The non-contact probe according to claim 6, further comprising a calibration amount calculating section that makes different a temperature calibration amount corresponding to a temperature of the image-formation position in a case where the temperature assessing section assesses that there is the temperature increase and a temperature calibration amount corresponding to a temperature of the image-formation position in a case where the temperature assessing section assesses that there is the temperature decrease.

8. The non-contact probe according to claim 7, wherein the calibration amount calculating section makes the temperature calibration amount corresponding to the temperature of the image-formation position in a case where the temperature assessing section assesses that there is the temperature increase greater than the temperature calibration amount corresponding to the temperature of the image-formation position in a case where the temperature assessing section assesses that there is the temperature decrease.

9. The non-contact probe according to claim 7, further comprising a distance calculating section that calibrates a distance to the measurement target object on a basis of the temperature calibration amount determined by the calibration amount calculating section.
